(19) United States
(12) Patent Application Publication
(10) Pub. No.: US 2019/0236676 A1
(43) Pub. Date: Aug. 1, 2019

(54) INTELLIGENT RECOMMENDATION ENGINE

(71) Applicant: WAL-MART STORES, INC., Bentonville, AR (US)

(72) Inventors: Kannan Achan, Saratoga, CA (US); Hyun Duk Cho, San Francisco, CA (US); Sushant Kumar, Sunnyvale, CA (US)

(73) Assignee: WAL-MART STORES, INC., Bentonville, AR (US)

(21) Appl. No.: 15/884,071

(22) Filed: Jan. 30, 2018

(51) Int. Cl. G06Q 30/06; G06N 5/04

(52) U.S. Cl. CPC G06Q 30/0631; G06Q 30/0635; G06N 5/04

(57) ABSTRACT

Systems and methods including one or more processing modules and one or more non-transitory storage modules storing computing instructions configured to run on the one or more processing modules and perform acts of: receiving recipes in an electronic manner; parsing the recipes to identify ingredients; generating mapping information that correlates the recipes with corresponding ingredients, and that correlates the ingredients with corresponding grocery products; executing a recommendation engine that is configured to recommend a recipe selected to a user based, at least in part, on the user's shopping behavior; utilizing the mapping information to select a subset of the grocery products that correspond to the ingredients for the recipe; transmitting data for presenting a recommendation display to the user that presents the subset of the grocery products and enables the grocery products to be added to an online shopping cart. Other embodiments are disclosed herein.

### TECHNICAL FIELD

This disclosure relates generally to recommendation engines that utilize mapping rules, scoring metrics and/or learning algorithms to provide intelligent recipe recommendations.

### BACKGROUND

In recent years, the amount of individuals who engage in online grocery shopping has steadily increased. Customers can order groceries online, and the orders can be delivered directly to the customers or can be picked-up by the customers at physical store locations (e.g., brick and mortar locations). While ordering groceries online can save customers time and effort associated with finding and selecting items within a physical store location, recent studies have shown that customers still spend significant amounts of time and effort selecting recipes. In many cases, customers do not select the recipes until after the groceries have been purchased. Consequently, after a customer has selected a desired recipe, the customer often realizes that he or she is missing one or more of the ingredients required by the selected recipe. In these scenarios, customers are forced to take additional trips to purchase the missing ingredients or to cook a meal that does not include one or more of the ingredients identified in the recipe.

### BRIEF DESCRIPTION OF THE DRAWINGS

To facilitate further description of the embodiments, the following drawings are provided in which:

FIG. 1 illustrates a front elevational view of a computer system that is suitable for implementing various embodiments of the systems disclosed in FIGS. 3 and 6;

FIG. 2 illustrates a representative block diagram of an example of the elements included in the circuit boards inside a chassis of the computer system of FIG. 1;

FIG. 3 illustrates a representative block diagram of a system according to certain embodiments;

FIG. 4 illustrates exemplary mapping information according to certain embodiments;

FIG. 5 is a flowchart for a method according to certain embodiments; and

FIG. 6 illustrates a representative block diagram of a portion of the system of FIG. 3 according to certain embodiments.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

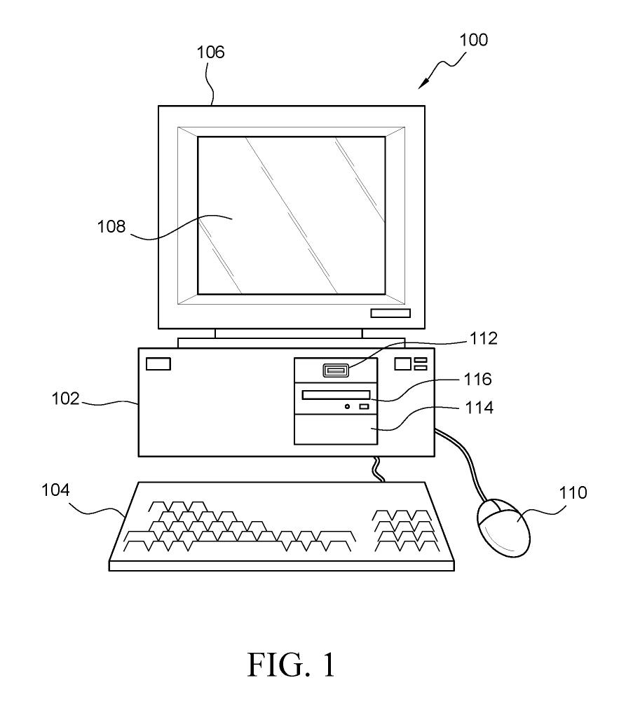

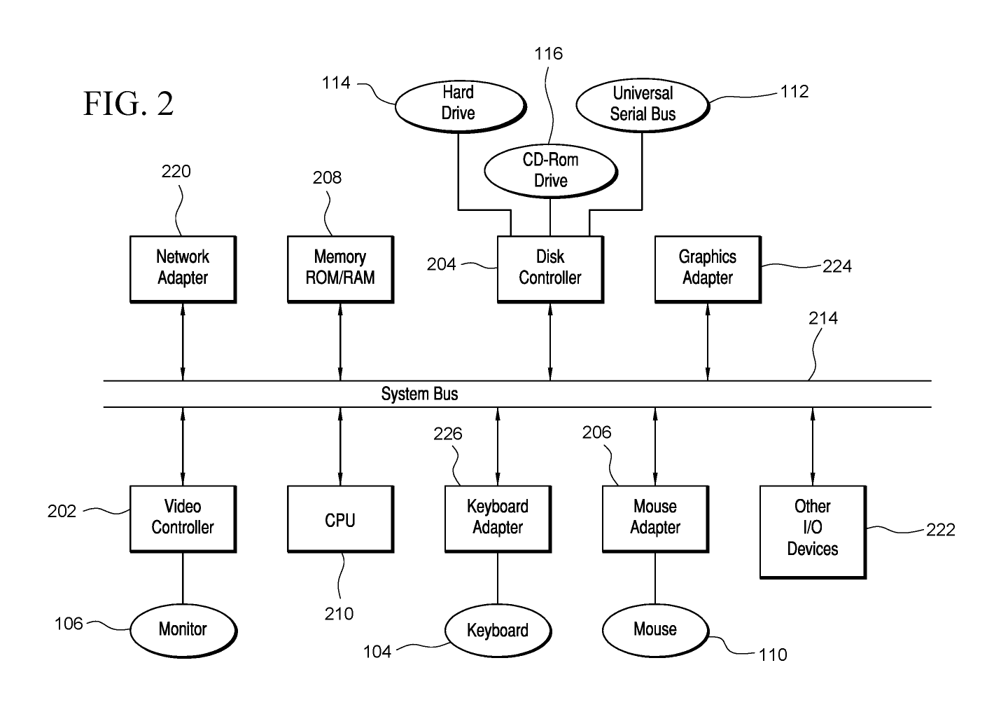

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) non-volatile memory, such as, for example, read only memory (ROM) and/or (ii) volatile memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In these or other embodiments, memory storage unit 208 can comprise (i) non-transitory memory and/or (ii) transitory memory.

In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

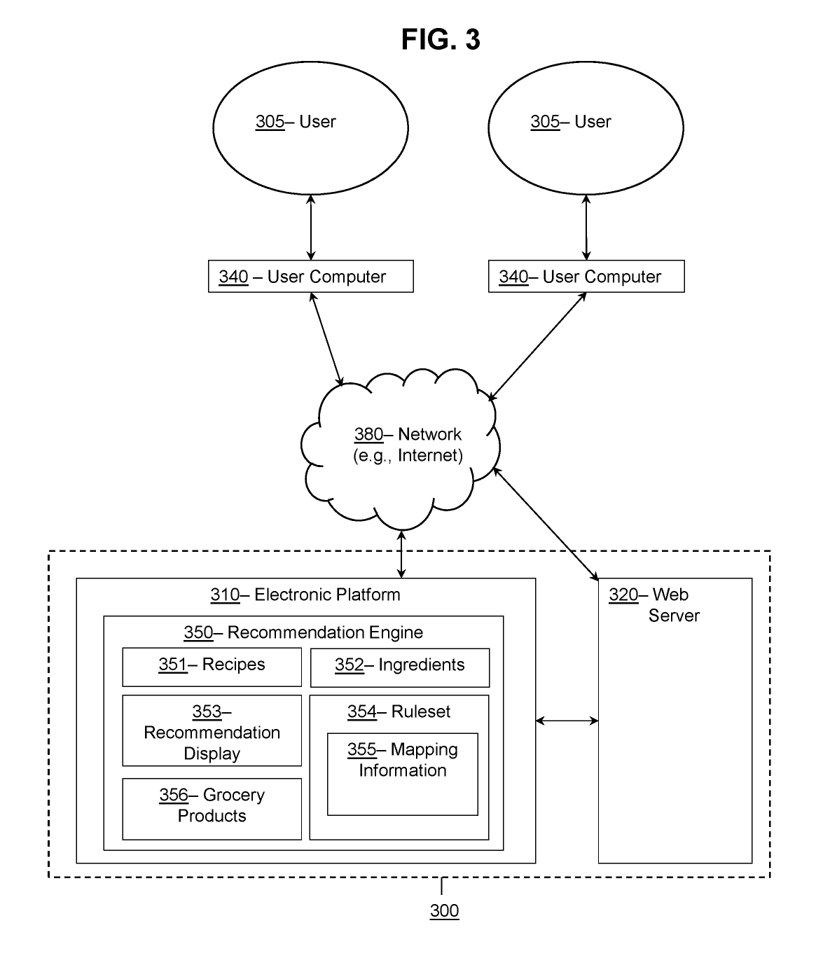

Turning ahead in the drawings, FIG. 3 illustrates a block diagram of a system 300 that can be employed for intelligently recommending recipes as described in greater detail below. System 300 is merely exemplary and embodiments of the system are not limited to the embodiments presented herein. System 300 can be employed in many different embodiments or examples not specifically depicted or described herein. In some embodiments, certain elements or modules of system 300 can perform various procedures, processes, and/or activities. In these or other embodiments, the procedures, processes, and/or activities can be performed by other suitable elements or modules of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include an electronic platform 310 and/or a web server 320. The electronic platform 310 can include a recommendation engine 350. The electronic platform 310, the web server 320, and/or the recommendation engine 350 can each be a computer system, such as computer system 100 (FIG. 1), as described above, and can each be a single computer, a single server, or a cluster or collection of computers or servers, or a cloud of computers or servers. In another embodiment, a single computer system can host each of two or more electronic platform 310, the web server 320, and/or the recommendation engine 350 are described herein.

In many embodiments, system 300 also can comprise user computers 340. In some embodiments, user computers 340 can be mobile devices. A mobile electronic device can refer to a portable electronic device (e.g., an electronic device easily conveyable by hand by a person of average size) with the capability to present audio and/or visual data (e.g., text, images, videos, music, etc.). For example, a mobile electronic device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile electronic device can comprise a volume and/or weight sufficiently small as to permit the mobile electronic device to be easily conveyable by hand. For examples, in some embodiments, a mobile electronic device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile electronic device can weigh less than or equal to 15.6 Newtons, 17.8 Newtons, 22.3 Newtons, 31.2 Newtons, and/or 44.5 Newtons.

Exemplary mobile electronic devices can comprise (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile electronic device can comprise an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, Calif., United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, N.Y., United States of America. In other specific examples, a head mountable wearable user computer device can comprise the Virtual Retinal Display™ product, or similar product by the University of Washington of Seattle, Wash., United States of America. Meanwhile, in further specific examples, a limb mountable wearable user computer device can comprise the iWatch™ product, or similar product by Apple Inc. of Cupertino, Calif., United States of America, the Galaxy Gear or similar product of Samsung Group of Samsung Town, Seoul, South Korea, the Moto 360 product or similar product of Motorola of Schaumburg, Ill., United States of America, and/or the Zip™ product, One™ product, Flex™ product, Charge™ product, Surge™ product, or similar product by Fitbit Inc. of San Francisco, Calif., United States of America.

In some embodiments, web server 320 can be in data communication through a network 380 (e.g., the Internet) with user computers (e.g., 340). In certain embodiments, user computers 340 can be desktop computers, laptop computers, smart phones, tablet devices, and/or other endpoint devices. Web server 320 can host one or more websites. For example, web server 320 can host an eCommerce website that allows users to browse and/or search for products, to add products to an electronic shopping cart, and/or to purchase products, in addition to other suitable activities.

In many embodiments, electronic platform 310, the web server 320, and/or the recommendation engine 350 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) of the electronic platform 310, the web server 320, and/or the recommendation engine 350 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of the electronic platform 310, the web server 320, and/or the recommendation engine 350. In a similar manner, the processing module(s) and the memory storage module(s) can be local and/or remote to each other.

In many embodiments, the electronic platform 310, the web server 320, and/or the recommendation engine 350 can be configured to communicate with one or more user computers 340. In some embodiments, user computers 340 also can be referred to as customer computers. In some embodiments, the electronic platform 310, the web server 320, and/or the recommendation engine 350 can communicate or interface (e.g., interact) with one or more customer computers (such as user computers 340) through a network 380, e.g., such as one that includes the Internet. Network 380 can be an intranet that is not open to the public. Accordingly, in many embodiments, the electronic platform 310, the web server 320, and/or the recommendation engine 350 (and/or the software used by such systems) can refer to a back end of system 300 operated by an operator and/or administrator of system 300, and user computers 340 (and/or the software used by such systems) can refer to a front end of system 300 used by one or more users 305, respectively. In some embodiments, users 305 also can be referred to as customers, in which case, user computers 340 can be referred to as customer computers. In these or other embodiments, the operator and/or administrator of system 300 can manage system 300, the processing module(s) of system 300, and/or the memory storage module(s) of system 300 using the input device(s) and/or display device(s) of system 300.

Meanwhile, in many embodiments, the electronic platform 310, the web server 320, and/or the recommendation engine 350 also can be configured to communicate with one or more databases. The one or more databases can comprise a product database that contains information about products, items, or SKUs (stock keeping units) sold by a retailer. The one or more databases can be stored on one or more memory storage modules (e.g., non-transitory memory storage module(s)), which can be similar or identical to the one or more memory storage module(s) (e.g., non-transitory memory storage module(s)) described above with respect to computer system 100 (FIG. 1). Also, in some embodiments, for any particular database of the one or more databases, that particular database can be stored on a single memory storage module of the memory storage module(s), and/or the non-transitory memory storage module(s) storing the one or more databases or the contents of that particular database can be spread across multiple ones of the memory storage module(s) and/or non-transitory memory storage module(s) storing the one or more databases, depending on the size of the particular database and/or the storage capacity of the memory storage module(s) and/or non-transitory memory storage module(s).

The one or more databases can each comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between the electronic platform 310, the web server 320, and/or the recommendation engine 350, and/or the one or more databases can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3 (also known as Ethernet), IEEE 802.11 (also known as WiFi), etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.).

A number of embodiments can include a system. The system can include one or more processing modules and one or more non-transitory storage modules storing computing instructions configured to run on the one or more processing modules. The one or more storage modules can be configured to run on the one or more processing modules and perform the act of: receiving recipes in an electronic manner; parsing the recipes in an electronic manner to identify ingredients included in each of the recipes; generating mapping information that correlates each of the recipes with the ingredients corresponding to the recipes, and that correlates each of the ingredients with grocery products corresponding to the ingredients; executing a computerized recommendation engine that is configured to recommend a recipe selected from the recipes to a user based, at least in part, on the user's shopping behavior; utilizing the mapping information to select in an electronic manner a subset of the grocery products that correspond to the ingredients for the recipe; and transmitting data for presenting to the user, via a graphic user interface on an electronic device, a recommendation that presents the subset of the grocery products and that enables the subset of the grocery products to be added to an online shopping cart of the user.

Various embodiments include a method. The method can include: receiving recipes in an electronic manner; parsing the recipes in an electronic manner to identify ingredients included in each of the recipes; generating mapping information that correlates each of the recipes with the ingredients corresponding to the recipes, and that correlates each of the ingredients with grocery products corresponding to the ingredients, wherein the mapping information is stored on one or more non-transitory storage modules; executing, with one or more processing modules, a computerized recommendation engine that is configured to recommend a recipe selected from the recipes to a user based, at least in part, on the user's shopping behavior; utilizing the mapping information to select in an electronic manner a subset of the grocery products that correspond to the ingredients for the recipe; and transmitting data for presenting to the user, via a graphic user interface on an electronic device, a recommendation that presents the subset of the grocery products and that enables the subset of the grocery products to be added to an online shopping cart of the user.

As mentioned above, ordering groceries online can save customers time and effort. The groceries can be picked up at physical store locations or the groceries can be delivered directly to the customers. However, customers still spend significant amounts of time and effort selecting recipes to use. Moreover, after customers select the recipes, the customers often realize that they forgot to order one or more of the ingredients necessary to make the selected recipe. In these scenarios, customers can either take an additional trip to the store to purchase the missing ingredients, or they cook a meal that does not include one or more of the ingredients required by the recipe.

The principles discussed in this disclosure relate to a recommendation engine that overcomes the aforementioned problems, as well as other problems. The recommendation engine intelligently identifies relevant recipes and corresponding grocery products to present to customers while the customers are shopping at an online storefront. The recommendation engine can be configured to monitor and analyze the current activities of the customers (e.g., by monitoring which groceries are being added to an online shopping cart) and/or previous activities of the customers (e.g., by determining prior purchases (whether recently made or not) by the customers). The recipes and grocery products selected for presentation to the customers can be based, at least in part, on the current activities and/or previous activities of the customers. The selection of the recipes and corresponding grocery products also can be based on various scoring metrics (e.g., such as the relevance scores and bypass scores described below) that are generated by the recommendation engine to select the most relevant recipes, and mapping information that enables customized selections of the grocery products for the selected recipes. Customers interested in the presented recipes can instantly and easily select an option for adding the corresponding grocery products to their online shopping carts.

Referring back to FIG. 3, the electronic platform 310 can provide an online shopping website that allows users 305 to browse products, add the products to an electronic shopping cart, place an order to obtain the products by delivery or pick-up, purchase the products, and/or other related activities. The website can be affiliated with and/or operated by an online retailer, supermarket, grocery store, or other entity. The web server 320 can provide assistance with hosting the website, enabling users to access and interact with the website, and/or other related functions.

The products made available on the electronic platform 310 can include grocery products 356. The grocery products 356 can include, inter alia, any type of item that is associated with food products and/or beverage products. Exemplary grocery products 356 can include: perishable and non-perishable food items, perishable and non-perishable beverage items, dairy items, grain items, meat items, vegetable items, fruit items, spices, garnishes, seasonings, condiments, sauces, dessert items, bakery items, soup items, canned/jarred items, and any other types of grocery products, such as items needed to prepare, cook, serve, and/or eat the aforementioned grocery products (e.g., a cheese grater, a strainer, a cutting board, a frying pan, a serving spoon, and/or a soup bowl). For each grocery product 356, the electronic platform 310 can offer a plurality of different brand options (e.g., similar products offered by different companies) and a plurality of different packaging options (e.g., packages that include different quantities, sizes and/or amounts). The products made available on the electronic platform 310 can include other types of products as well. Any of the aforementioned grocery products 356 can be used as ingredients 352 for recipes 351 as discussed below.

The users 305 can access the electronic platform 310 to browse through the available grocery products 356. The users 305 can select options for adding grocery products 356 to an online shopping cart, and the users 305 can purchase the grocery products 356 included in the online shopping cart via a checkout process. The checkout process can permit the users 305 to specify whether the grocery products 356 ordered by the users 305 will be picked up at a physical store location and/or delivered to the users 305.

While the users 305 are shopping or otherwise interacting with the electronic platform 310, the recommendation engine 350 can present the users 305 with recommendations for recipes 351, listings of corresponding ingredients 352 for the recipes, and listings of grocery products 356 corresponding to the ingredients of the recipe. For example, the electronic platform 350 can generate a recommendation display 353 that includes information associated with recommended recipes 351. The recommendation display 353 can include names or titles for one or more recipes 351, a listing of ingredients 352 associated with the recipes, and/or a listing of grocery products 356 corresponding to the ingredients 352. As explained in further detail herein, the recommendation engine 350 utilizes novel techniques for selecting and presenting the information that is included in the recommendation display 353. The recommendation display 353 can be transmitted to the users 305 (e.g., over the network 380 to the user computers 340) and incorporated into web pages or other graphic user interfaces (e.g., via e-mails, mobile application interfaces, or pop-up windows) to be displayed to the users 305. The users 305 can select options for adding the grocery products corresponding to the ingredients of the recipes 351 to their online shopping carts, thus allowing the users 305 to instantly purchase grocery products corresponding to all of the ingredients for the presented recipes.

The recipes 351 stored on the recommendation engine 350 can be provided in various ways. In certain embodiments, the recommendation engine 350 can retrieve the recipes 351 from web pages and/or databases associated with the electronic platform 310. The recipes 351 can alternatively, or additionally, be retrieved from third-parties over the network 380. For example, the recommendation engine 350 can retrieve the recipes 351 from websites hosted by third-parties that store recipe information. The recipes 351 can alternatively, or additionally, be provided by users 305 who wish to contribute the recipes 351 and/or can be manually entered (e.g., by an administrator or individual associated with the electronic platform 310). The recipes 351 can be provided in other ways as well.

In certain embodiments, the recommendation engine 350 can be configured to analyze and/or parse the recipes 351 to determine the ingredients 352 associated with the recipes 351. For example, in response to retrieving or receiving a recipe 351, the recommendation engine 350 can execute a natural language parsing function that analyzes the content of the recipe 351 to identify the ingredients 351 included in the recipe 351. In certain embodiments, the natural language parsing function can also be utilized to determine other information associated with the recipe 351. For example, the natural language parsing function can be configured to determine amounts or quantities of each ingredient 352, preparation instructions (e.g., which can indicate when ingredients should be stirred, mixed or used in other ways), cooking instructions (e.g., which can indicate lengths of cook times and appliances to be used), and other related information.

The recommendation engine 350 can store data for each of the recipes 351 and ingredients 3532 on the electronic platform 310. Each of the recipes 351 can be assigned and associated with a recipe identifier (recipe ID) and each of the ingredients can be assigned and associated with an ingredient identifier (ingredient ID). For each ingredient 352, the electronic platform 310 can store data for one or more grocery products 356 that corresponding to the ingredient 352. Each of the grocery products 356 also can be assigned and associated with a product identifier (product ID). In certain embodiments, the recipe IDs, ingredient IDs and product IDs can be utilized to uniquely identify each of the recipes 351, the ingredients 352, and the grocery products 356, respectively.

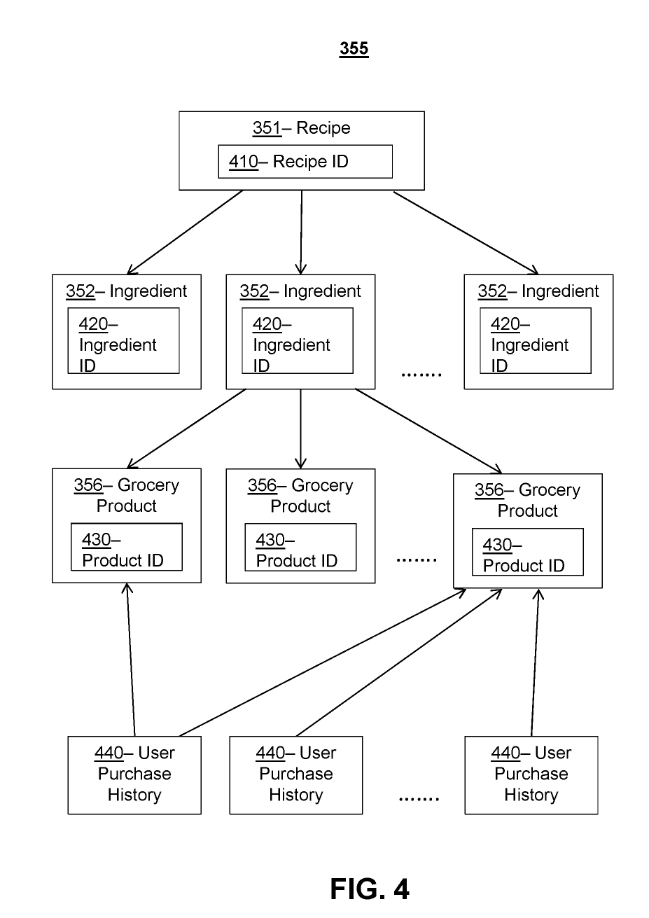

The recommendation engine 350 stores a ruleset 354 that can be used, at least in part, to select grocery products 356 associated with the recipes 351 for presentation in the recommendation display 353. The ruleset 354 can include mapping information 355 that utilizes the recipe IDs, ingredient IDs and product IDs to correlate each of the stored recipes 351 with one or more ingredients 352, and to correlate each of the ingredients with one or more grocery products 356. The mapping information 355 enables the recommendation engine 350 to present a user 305 with a recipe recommendation that includes a set of grocery products 356 that correspond to the ingredients 352 of a recipe 351. Because the electronic platform 310 can store multiple grocery products 356 for each ingredient 352, the selection of the specific grocery products 356 that are included in the recommendation to the user can be based, at least in part, on previous purchases made by the customer (e.g., based on specific brands or specific products that were previously purchased by the customer) and/or current activities of the customer (e.g., based on brands or products that are currently included in the user's online shopping cart). Further details regarding use of the ruleset 354 and corresponding mapping information 355 are discussed below with reference to FIG. 4.

In addition to using the mapping information 355, the recommendation engine 350 can be configured to weigh a variety of factors to enable the intelligent automated selection of the recipes 351 and the grocery products 356. Each of these factors is discussed in further detail below.

One factor the recommendation engine 350 can use to select the recipes 351 can be based on the current activities of the user 305. For example, the recommendation engine 350 can monitor the grocery products that are currently added to a user's online shopping cart and recommend recipes based, at least in part, on the contents of the shopping cart. For example, if a user has currently added chicken and lemon to the online shopping cart, the recommendation engine 350 can recommend a recipe that includes these ingredients (e.g., a recipe for lemon chicken dish). The recommendations be based on other types of activities currently being performed by the user (e.g., based on products that the user is currently browsing or has recently browsed, or based on search terms entered by the user in a search engine provided by the electronic platform 310). Any of the users' current activities can influence the selection of the recipes 351 that are recommended by the recommendation engine 350.

Another factor the recommendation engine 350 can consider in selecting the recipes 351 can be based on the previous activities of the users 305. For example, the recommendation engine 350 can analyze data associated with previous orders placed by a user 305 to identify grocery products 356 that were previously purchased by the user 305, and the recommendation engine 350 can recommend recipes 351 that include the products previously purchased by the user 351. For example, if a user consistently purchases steak and bread each week, the recommendation engine 350 can recommend a recipe that includes these ingredients (e.g., a recipe for steak tidbits). As another example, if a user purchased a container of baking powder last week, the recommendation engine 350 could assume that the user still has some baking powder remaining and, thus, could recommend a recipe that uses baking powder. Other types of previous activities performed by the user may be considered in recommending the recipes 351. For example, recipes 351 can be recommended based on previous recipes that were selected by the user 305 and/or based on ratings of the recipes provided by the users 305. Any of the users' previous activities can influence the selection of the recipes 351 that are recommended by the recommendation engine 350.

The previous activities of the users 305 also can be utilized to select the grocery products 356 that are presented in the recommendations to the users 305. For example, if the electronic platform 310 offers multiple products that can be used for one of the ingredients 352 of a recipe 351, then the recommendation engine 350 can select one of the products to be presented to the user 305 based on the previous activities of the users 305. For example, in certain embodiments, the recommendation engine 350 can be configured to select the product that was previously purchased by the user 305, to select a product that was purchased most often by the user 305 (e.g., by comparing the number of times each of the available alternative products were purchased), and/or to select the product that was most recently purchased by the user 305. The recommendation engine 350 can perform these activities by generating and selecting mapping information 355 that correlates the users 305 to previously purchased grocery products 356. Any of the users' previous activities can influence the selection of the grocery products 356 that are recommended by the recommendation engine 350.

Another factor the recommendation engine 350 can consider in selecting the recipes 351 and grocery products 356 can be based on feedback from the results of prior recommendations. The recommendation engine 350 can record previous recommendations that were presented to each of the users and this information can be utilized to optimize and customize the selections of the recipes 351 and grocery products 356 that are presented to the user 305. For example, if the user 305 was previously presented with a specific recipe on several occasions and if the user 305 ignored the recommended recipe (e.g., by not adding the recipe to the online shopping cart and/or not purchasing the associated grocery products) each time, then the recommendation engine 350 can be configured to determine that the user 305 is not interested in the recipe, and the recipe should not be recommended to the user 305. As another example, if the user 305 chose to use a recommended recipe in the past, but did not purchase the specific grocery products that were included in the recommendation presented in the recommendation display 353 (e.g., the user chose to purchase alternative brands of the grocery products), then the recommendation engine 350 can assume that the user 305 prefers the specific products that were purchased in comparison to the previously recommended products. The recommendation engine 350 can thereafter present the products preferred by the user 305 in future recommendations. Feedback from previous recommendations can be used in other ways as well.

In certain embodiments, the recommendation engine 350 further utilizes scoring metrics to select the recipes that are presented to the users 305. For example, in certain embodiments, the ingredients 352 of the recipes 351 are assigned relevance scores that can be utilized to determine whether or not a user will be interested in receiving the recipes 352. The relevance scores for each ingredient 352 can vary based on the recipes 351. In certain embodiments, the relevance scores can be assigned to the ingredients 352 based on how common or uncommon the ingredients are and/or based on whether or the ingredients are staple ingredients for a specific recipe 351. The relevance scores can be represented using numerical indicators (e.g., on a scale from 1-100) or in other ways. In certain embodiments, the relevance scores for each recipe 351 can be tallied, combined, and/or otherwise considered in a collective manner to estimate a user's interest in the recipe 351. In certain embodiments, the collective relevance scores corresponding to each recipe can then be compared to certain threshold to determine whether recipes should be recommended to the users 305.

To illustrate by way of example, consider an example in which the recommendation engine 350 is determining whether or not to present the user 305 with a recipe for a lemon chicken dish, and the ingredients associated with the recipe include chicken, lemon, salt, pepper and flour. Lemon and chicken are the staple ingredients in the recipe and are less common than many other ingredients, while salt, pepper and flour are common ingredients that are used in many recipes. Thus, the chicken and lemon ingredients can be assigned higher relevance scores, while the other ingredients can be assigned lower relevance scores. The recommendation engine 350 can analyze the content of the user's online shopping cart to identify the ingredients in the online shopping cart. Because the relevance scores assigned to the chicken and lemon products are greater, the recommendation engine 350 can determine that the user is likely to be interested in the lemon chicken recipe in response to determining that the user's online shopping cart includes lemon and/or chicken ingredients. However, if the online shopping cart included only the products having lower relevance scores (e.g., salt, pepper and/or flour), it is unlikely that the recommendation engine 350 would recommend the lemon chicken recipe because these ingredients are common ingredients that can be used in many recipes, and they do not provide a sufficient indication that the user will be interested in the lemon chicken.

In certain embodiments, as a user adds grocery products 356 to an online shopping cart, the recommendation engine 350 uses the relevance scores to dynamically estimate the user's interest in each of the recipes 351 stored by the recommendation engine 350. The recommendation engine 350 can identify the recipes 351 that are likely to be of greatest interest to the user by analyzing the shopping cart content, identifying the recipes that include the ingredients, determining relevance scores for the ingredients, estimating a user's interest level in each of the recipes based on the relevance scores, and selecting one or more recipes 351 to present to the user 305 in the recommendation display 353.

It should be recognized that the relevance scores assigned to the ingredients 352 can vary based on the recipes 351. For example, while a lemon ingredient can be assigned a high relevance score for a first recipe, a lemon ingredient can be assigned a low relevance score for a second recipe. As a user adds grocery products 356 to the online shopping cart, the recommendation engine 350 can analyze the relevance scores separately for each of the recipes in order to estimate the users' interest in the recipes. In certain embodiments, the relevance scores can be used to compute an overall score for each recipe that reflects the estimated user interest in each of the recipes. A recipe 351, or set of recipes 351, determined to be of high interest to the user 305 can then be transmitted to the users 305 via the recommendation display 353.

Another scoring metric that can be utilized by the recommendation engine 350 to select recipes 351 for recommendations can include bypass scores associated with the recipes 351. Generally speaking, a bypass score is a score that can be used by the recommendation engine 350 to determine that a user is not interested in a recipe 351 (and, therefore, the recipe should be ignored or bypassed). The recommendation engine 350 can generate a bypass score for each of the recipes 351 stored by the recommendation engine 350. In certain embodiments, higher bypass scores can indicate higher likelihoods that a recipe is not of interest, while lower bypass scores can indicate lower likelihoods that a recipe is not of interest. The recommendation engine 350 can update the bypass scores by analyzing current and/or previous user activities. The bypass scores can be represented using numerical indicators (e.g., on a scale from 1-100) or in other ways. In certain embodiments, the bypass scores can be compared to a threshold to determine whether recipes should be removed from consideration in determining the recommendations that are presented to the users 305.

In certain embodiments, the bypass score can be increased in response to determining that a user already has knowledge of a recipe. For example, the recommendation engine 350 can determine that a user already has knowledge of a recipe because the user's online shopping cart includes all or most of the ingredients for the recipe. In such scenarios, the recommendation engine 350 can determine that the recipe 351 should not be presented to the user 305. Similarly, the bypass score can also be increased in response to determining that the user previously ignored recommendations for a recipe, and the recommendation engine 350 can determine that the recipe 351 should not be presented in any further recommendations to the user 305.

It should be recognized that other factors can be utilized by the recommendation engine 350 to determine that recommendations for certain recipes should not be recommended or presented and/or should be bypassed. The examples discussed above are merely intended to illustrate how the bypass scores can be used by the recommendation engine 350 to select or avoid selection of certain recipes.

As demonstrated above, the recommendation engine 350 is able to intelligently select the recipes 351 by considering a variety of factors including the current activities of the users 305, previous activities of the users 305, feedback from prior recipe recommendations, relevance scores associated with the ingredients, and/or bypass scores indicating when recipes should be removed from consideration. The ruleset 354 of the recommendation engine 350 can include rules, instructions and/or programming logic which can determine if any or all of these factors are to be considered by the recommendation engine 350, and the importance that is to be assigned to each of these factors. The ruleset 354 can be modified to adjust the importance settings of these factors. Once the recipes are selected for presentation to users, the recommendation engine 350 can utilize the mapping information 355 stored in the ruleset 354 to identify corresponding grocery products 356 for the recipe, and the specific grocery products selected by the recommendation engine 350 can be customized based on the users' prior purchases.

As evidenced by the disclosure herein, the principles set forth in the disclosure are rooted in computer technologies that overcome existing problems in known recommendation systems. Known recommendation systems do not intelligently identify and recommend recipes with corresponding grocery products to the users. Rather, users are typically required to spend significant amounts of time to select recipes on their own. The principles described in this disclosure provide a technical solution (e.g., one that utilizes intelligent recommendation engine that considers various factors to select optimal recipes, and that utilizes a ruleset with mapping information to select corresponding grocery products) for overcoming such problems. This technology-based solution marks an improvement over existing computing capabilities and functionalities related to recommendation systems by improving the effectiveness and accuracy of recipe recommendations and corresponding products. The novel recommendation engines described herein are designed to expedite and automate the selection of recipes and placing of orders via electronic platforms.

Turning ahead to the next figure, FIG. 4 illustrates exemplary mapping information 355 that can be stored in the ruleset 354 to assist the recommendation engine 350 (FIGS. 3 & 6) with selecting grocery products 356. This example is one embodiment that demonstrates how a single recipe 351 can be mapped to one or more grocery products 356. However, it should be recognized that the ruleset 354 can include similar mapping information 355 for each of the recipes 351 stored by the recommendation engine 350 (FIGS. 3 & 6).

As shown, the recipe 351 includes a recipe ID 410, the ingredients 352 include ingredient IDs 420, and the grocery products 356 include product IDs 430. In certain embodiments, the recipe ID 410 can be used to uniquely identify the recipe 351, the ingredient IDs 420 can be used to uniquely identify the ingredients 352, and the product IDs 430 can be used to uniquely identify the grocery products 356.

The recipe 351 is mapped to a plurality of different ingredients 352. More specifically, the recipe 351 is mapped to a plurality of ingredients 352 that can be required to make the recipe 351. In certain embodiments, the recipe 351 can be mapped to the ingredients 352 by storing information in the ruleset 354 (FIG. 3) which correlates the recipe ID 410 with each of the ingredient IDs 420.

As mentioned above, the electronic platform 310 (FIGS. 3 & 6) can store a plurality of different products that correspond to each of the ingredients 352. For example, if one of the ingredients 352 was for peanut butter, the electronic platform 310 (FIGS. 3 & 6) can store several different brands of peanut butter (e.g., PB Brand 1, PB Brand 2, PB Brand 3, etc.). Each ingredient 352 can be mapped to all of the grocery products 356 that correspond to the ingredient 352. In certain embodiments, the ingredients 352 can be mapped to the grocery products 356 by storing information in the ruleset 354 that correlates each of the ingredients IDs 410 to each of the product IDs 430 for the corresponding grocery products 356.

After the recommendation engine 350 selects one or more of the recipes 351 to present to a user 305, the recommendation engine 350 (FIGS. 3 & 6) can utilize the above-described mapping information 355 to identify a set of grocery products 356 that can be presented to the user 305 in connection with the selected recipes 351.

In certain embodiments, the mapping information 355 can further be used to map a user purchase history 440 for each of the users 305 (FIG. 3) to the grocery products 356 to enable the recommendation engine 350 (FIGS. 3 & 6) to identify the grocery products 356 that were previously purchased by each of the users 305 (FIG. 3). The user purchase history 440 can provide any information relating to previous purchases made by the user. For example, the user purchase history 440 for a user 305 can identify orders that were placed by the users 305 (FIG. 3), grocery products that were purchased in connection with the orders, pricing information associated with the products and the orders, dates of purchases, and other related information.

In certain embodiments, the recommendation engine 350 (FIGS. 3 & 6) can utilize the user purchase history 440 to select the specific grocery products that are to be presented in connection with the recipe recommendations. More specifically, if a variety of different grocery products 356 can be selected for an ingredient 352, then the recommendation engine 350 can utilize the user purchase history 440 to determine if the user previously purchased one or more of the available grocery products 356. If the user had previously purchased one of the available grocery products 356, then it can be assumed that the user 305 prefers the previously purchased grocery product 356, and the recommendation engine 350 (FIGS. 3 & 6) can select that grocery product 356 to be presented with the recipe recommendation. If the user 305 had previously purchased more than one of the available grocery products 356, the recommendation engine 350 (FIGS. 3 & 6) can select the grocery product 356 that was purchased most frequently, the grocery product 356 that was purchased most recently, and/or the grocery product 356 that is cheapest in price. In this manner, the recommendation engine 350 (FIGS. 3 & 6) can customize the grocery products 356 that are presented in connection with the recipe recommendations based on the users' purchase histories 440.

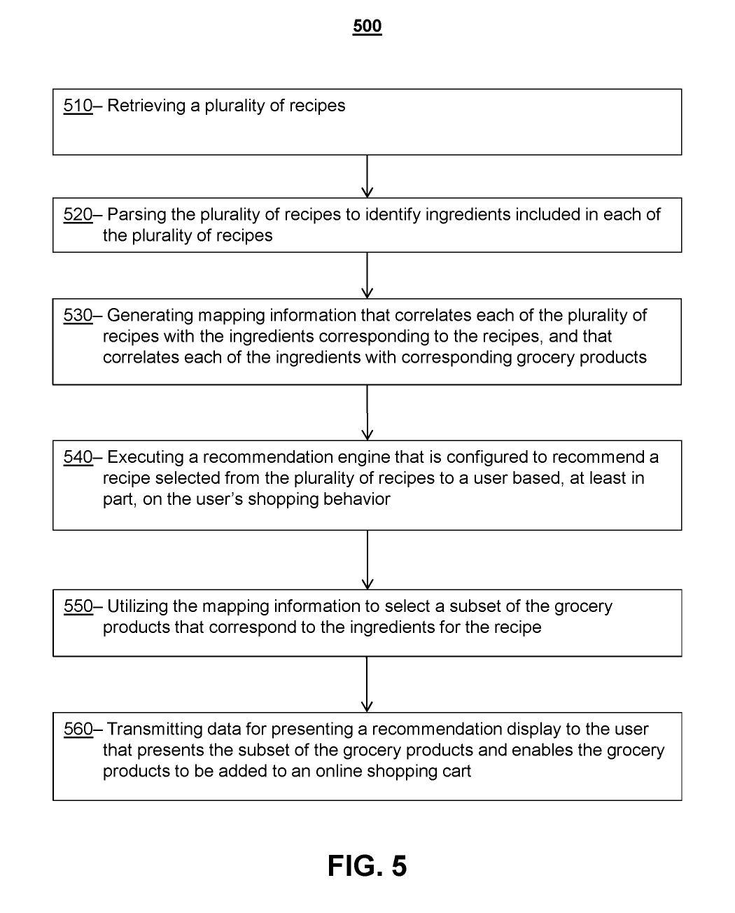

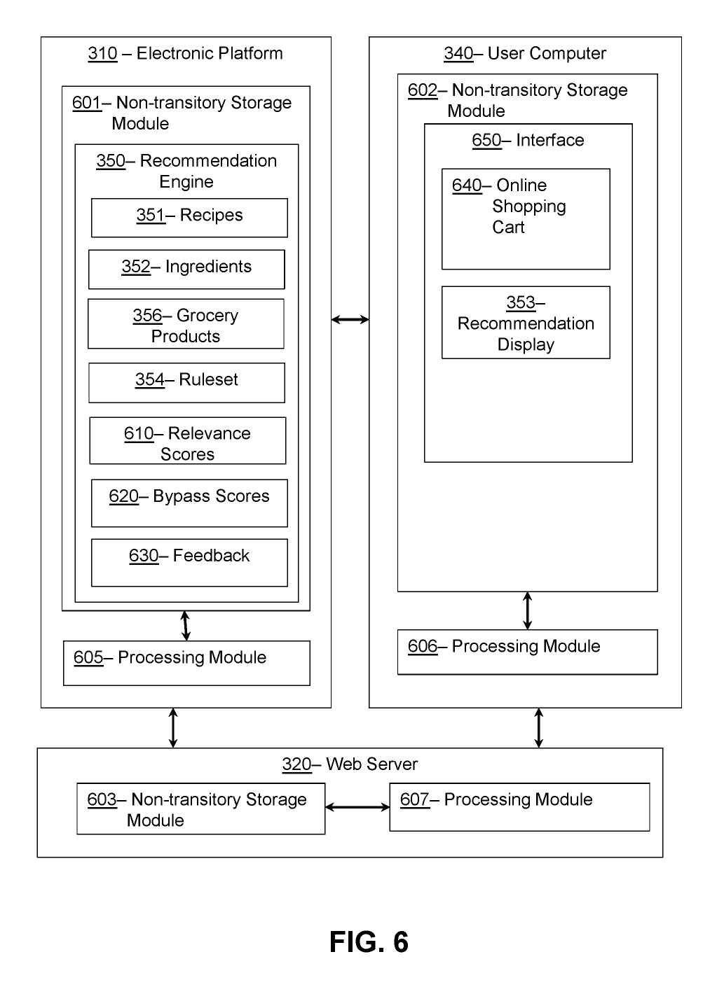

Turning ahead to FIG. 5, this figure illustrates a flow chart for a method 500 according to certain embodiments. Method 500 is merely exemplary and is not limited to the embodiments presented herein. Method 500 can be employed in many different embodiments or examples not specifically depicted or described herein. In some embodiments, the activities of method 500 can be performed in the order presented. In other embodiments, the activities of method 500 can be performed in any suitable order. In still other embodiments, one or more of the activities of method 500 can be combined or skipped. In many embodiments, system 300 (FIG. 3) can be suitable to perform method 500 and/or one or more of the activities of method 500. In these or other embodiments, one or more of the activities of method 500 can be implemented as one or more computer instructions configured to run at one or more processing modules 605, 606, 607 (FIG. 6) and configured to be stored at one or more non-transitory memory storage modules 601, 602, 603 (FIG. 6). Such non-transitory memory storage modules can be part of a computer system such as the electronic platform 310 (FIGS. 3 & 6), the web server 320 (FIGS. 3 & 6), and/or recommendation engine 350 (FIGS. 3 & 6). The processing module(s) can be similar or identical to the processing module(s) described above with respect to computer system 100 (FIG. 1).

Method 500 can comprise an activity 510 of retrieving a plurality of recipes in an electronic manner. In certain embodiments, the recipes can be retrieved from web pages and/or databases associated with electronic platform 310 (FIGS. 3 & 6). The recipes can additionally, or alternatively, be retrieved from third-party websites and/or manually input by individuals (e.g., administrators) associated with the electronic platform 310 (FIGS. 3 & 6).

Method 500 can comprise an activity 520 of parsing the plurality of recipes in an electronic manner to identify ingredients included in each of the plurality of recipes. The recommendation engine 350 (FIGS. 3 & 6) can be configured to parse the recipes by analyzing the recipes with natural language parsing functions. In addition to identifying ingredients in the recipes, the natural language parsing functions can further be utilized to determine other related information (e.g., information indicating amounts of ingredients to be used in connection with recipes, information indicating preparation instructions and/or information indicating cooking instructions).

Method 500 can comprise an activity 530 of generating mapping information that correlates each of the plurality of recipes with the ingredients corresponding to the recipes, and that correlates each of the ingredients with corresponding grocery products. As explained above, the mapping information can include data that associates a plurality of ingredients to each recipe (e.g., by mapping recipe IDs to ingredient IDs) and that associates a plurality of grocery products to each of the ingredients (e.g., by mapping ingredient IDs to product IDs). The mapping information can include data for establishing other types of correlations. For example, as explained above, the mapping information can further include data that associates each of the users with their purchases.

Method 500 can comprise an activity 540 of executing a computerized recommendation engine that is configured to recommend a recipe selected from the plurality of recipes to a user based, at least in part, on the user's shopping behavior. As explained above, the recommendation engine 350 (FIGS. 3 & 6) can consider a variety of factors in selecting the recipe to be presented to the user. Some of the factors can be based on the user's shopping behavior. For example, the recommendation engine 350 (FIGS. 3 & 6) can select the recipe based, at least in part, on the user's current shopping behavior (e.g., which can indicate grocery products that are added to the user's online shopping cart (e.g., before performing activity 540) and/or which indicate grocery products or grocery product categories the user is browsing) and/or based on the user's previous shopping behavior (e.g., which can indicate grocery products and/or orders previously placed by the user). Activity 540 also can select the recipe based, at least in part, on the fewest number of additional grocery products that need to be added to the user's online shopping cart in view of the grocery products that are already added to the user's online shopping cart and/or that were purchased previously by the user where the user likely still has some of that grocery product remaining. Activity 540 also can include, in some embodiments, transmitting the recommended recipe to the user via a graphic user interface on an electronic device.

Method 500 can comprise an activity 550 of utilizing the mapping information to select in an electronic manner a subset of the grocery products that correspond to the ingredients for the recipe. As explained above, each of the ingredients can be mapped to a plurality of grocery products (e.g., by mapping ingredient IDs to product IDs). For example, an ingredient for salt can be mapped to several different salt products, each of which is associated with a different brand. The mapping information can be used to select one of the products that are associated with the ingredient. This selection of one of the products can be based on, or influenced by, prior purchases made by the user. Thus, if the user previously purchased a product corresponding to an ingredient in the past, the recommendation engine 350 (FIGS. 3 & 6) can be programmed to select the product for presentation with the recommended recipe. The selection of the specific products that are presented in connection with the recipe recommendation can also be based on, or influenced by, other factors (e.g., such as pricing information for the products and/or whether the sizes of the products correspond to amounts of the ingredients.

Method 500 can comprise an activity 560 of transmitting data for presenting to the user, via a graphic user interface on an electronic device, a recommendation that presents the subset of the grocery products and that enables the subset of the grocery products to be added to an online shopping cart of the user. The recommendation can be presented to the user on web pages or other interfaces that are displayed on the user computers 340 (FIGS. 3 & 6). The recommendation also can identify the name or title of the recipe that is selected and/or otherwise present the recipe that is selected to the user. The recommendation further can include options for separately adding each of the subset of the grocery products included in the recommendation to an online shopping cart, and/or can include an “Add All” option that enables all of the subset of the grocery products to be instantly added to the online shopping cart. In some embodiments, the subset of the grocery products do not include grocery products that are already in the online shopping cart of the user or that were in the online shopping cart of the user before performing activity 540. In the same or different embodiments, activity 560 can include transmitting data for presenting to the user an indication of the other grocery products needed for the recipe (in addition to those included in the subset of the grocery products) that the user already has placed in the user's online shopping cart. Also in the same or different embodiments, the subset of the grocery products do not include grocery products that the user purchased previously and that the user might still have a portion remaining. In embodiments where activity 540 includes transmitting the recommended recipe to the user, the transmitting step in activity 540 can occur before activity 560.

FIG. 6 illustrates a block diagram of a portion of system 300 comprising electronic platform 310, web server 320, and user computer 340 in FIG. 3 according to certain embodiments. Each of the electronic platform 310, the web server 320, and the user computer 340, is merely exemplary and not limited to the embodiments presented herein. Each of the electronic platform 310, the web server 320, and the user computer 340, can be employed in many different embodiments or examples not specifically depicted or described herein. In some embodiments, certain elements or modules of the electronic platform 310, the web server 320, and the user computer 340, can perform various procedures, processes, and/or acts. In other embodiments, the procedures, processes, and/or acts can be performed by other suitable elements or modules.

The recommendation engine 350 stores data associated with a plurality of recipes 351, a plurality of ingredients 352, and a plurality of grocery products 356. The recommendation engine 350 selects recipes and corresponding grocery products to transmit to the user computer 340. More specifically, the recommendation engine 350 can generate a recommendation display 353 that identifies one or more recipes 351, as well as grocery products 356 corresponding to each of the recipes 351. The recommendation engine 350 transmits the recommendation display 353 to the user computer 340 (e.g., via network 380 in FIG. 3) which displays the recommendation display 353 on an interface 650 that is presented on the user computer 340. In certain embodiments, the interface 650 can be a web page interface, an application interface (e.g., mobile application interface), and/or other type of interface 650.

The recommendation engine 350 stores the ruleset 354 that enables the intelligent selection of the recipes 351 and grocery products 356 that are included in the recommendation display 353. For example, as explained above, the recommendation engine 350 can consider various factors in selecting the recipes 351 and the grocery products 356 including, but not limited to, the current activities of the users, previous activities of the users, feedback 630 from prior recipe recommendations, relevance scores 610 that indicate relevance weights that can be used to identify recipes of interest (e.g., based on how common on uncommon the ingredients are), and/or bypass scores 620 indicating when recipes should be removed from consideration. The ruleset 354 stores rules and logic that enable the recommendation engine 350 to select the recipes 351 and the grocery products 356 based on these factors. The ruleset 354 also stores mapping information 355 (FIG. 3) that enables the recommendation engine 350 to identify and select grocery products corresponding to the selected recipes 351.

If the user is interested in one or more of the recipes 351 recommended by the recommendation engine 350, the user can add the recipes 351 and corresponding ingredients to an online shopping cart 640. The user can then choose to purchase the grocery products included in the online shopping cart 640. The user can choose to have the purchased grocery products delivered, or can arrange to have the grocery products picked-up at a physical store location (e.g., at a brick and mortar location).

Although systems and methods for recommending recipes have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-6 may be modified, and that the foregoing discussion of certain of these embodiments does not necessarily represent a complete description of all possible embodiments. For example, one or more of the procedures, processes, or activities of FIG. 5 may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processing modules; and
one or more non-transitory storage modules storing computing instructions configured to run on the one or more processing modules and perform acts of:
receiving recipes in an electronic manner;
parsing the recipes in an electronic manner to identify ingredients included in each of the recipes;
generating mapping information that correlates each of the recipes with the ingredients corresponding to the recipes, and that correlates each of the ingredients with grocery products corresponding to the ingredients;
executing a computerized recommendation engine that is configured to recommend a recipe selected from the recipes to a user based, at least in part, on the user's shopping behavior;
utilizing the mapping information to select in an electronic manner a subset of the grocery products that correspond to the ingredients for the recipe; and
transmitting data for presenting to the user, via a graphic user interface on an electronic device, a recommendation that presents the subset of the grocery products and that enables the subset of the grocery products to be added to an online shopping cart of the user.

2. The system of claim 1, wherein the computerized recommendation engine is configured to (a) identify added ones of the grocery products that are included in the online shopping cart of the user before executing the computerized recommendation engine to recommend the recipe, and (b) recommend the recipe based, at least in part, on the added ones of the grocery products that are included in the online shopping cart before executing the computerized recommendation engine to recommend the recipe.

3. The system of claim 2, wherein the recommendation further presents the recipe to the user.

4. The system of claim 1, wherein the computerized recommendation engine is further configured to generate bypass scores that are utilized to determine whether one or more of the recipes should not be recommended to the user because the user already has knowledge of the one or more of the recipes.

5. The system of claim 1, wherein:
executing the computerized recommendation engine further comprises transmitting the recipe for presenting to the user via the graphic user interface on the electronic device; and
transmitting the recipe occurs before transmitting the data.

6. The system of claim 1, wherein:
the mapping information further correlates certain ones of the grocery products that were previously purchased by the user,
executing the computerized recommendation engine further comprises recommending the recipe selected from the recipes to the user further based in part on the certain ones of the grocery products that were previously purchased by the user; and
the subset of the grocery products included in the recommendation do not include the certain ones of the grocery products that were previously purchased by the user.

7. The system of claim 1, wherein:
each of the recipes are parsed to further identify ingredient amounts for the ingredients included in each of the recipes, and
the subset of the grocery products included in the recommendation are selected based, at least in part, on the ingredient amounts of the ingredients that correspond to the recipe that is selected by the computerized recommendation engine.

8. The system of claim 1, wherein the computerized recommendation engine is configured to analyze feedback associated with prior recommendations of other ones of the recipes that were presented to the user.

9. The system of claim 8, wherein the computerized recommendation engine is configured to analyze the feedback to identify additional recipes included in the recipes that are not of interest to the user in response to determining that the user previously ignored the prior recommendations.

10. The system of claim 1, wherein:
the subset of the grocery products comprise certain ones of the grocery products that correspond to the ingredients for the recipe and that are not included in the online shopping cart before executing the computerized recommendation engine to recommend the recipe;
transmitting the data further comprises transmitting the data for presenting to the user, via the graphic user interface on the electronic device, an indication of other grocery products that (a) correspond to other ones of the ingredients for the recipe and (b) are included in the online shopping cart before executing the computerized recommendation engine to recommend the recipe; and
the subset of the grocery products do not comprise the other grocery products.

11. A method comprising:
receiving recipes in an electronic manner;
parsing the recipes in an electronic manner to identify ingredients included in each of the recipes;
generating mapping information that correlates each of the recipes with the ingredients corresponding to the recipes, and that correlates each of the ingredients with grocery products corresponding to the ingredients, wherein the mapping information is stored on one or more non-transitory storage modules;
executing, with one or more processing modules, a computerized recommendation engine that is configured to recommend a recipe selected from the recipes to a user based, at least in part, on the user's shopping behavior;
utilizing the mapping information to select in an electronic manner a subset of the grocery products that correspond to the ingredients for the recipe; and
transmitting data for presenting to the user, via a graphic user interface on an electronic device, a recommendation that presents the subset of the grocery products and that enables the subset of the grocery products to be added to an online shopping cart of the user.

12. The method of claim 1, wherein the computerized recommendation engine is configured to (a) identify added ones of the grocery products that are included in the online shopping cart of the user before executing the computerized recommendation engine to recommend the recipe, and (b) recommend the recipe based, at least in part, on the added ones of the grocery products that are included in the online shopping cart before executing the computerized recommendation engine to recommend the recipe.

13. The method of claim 12, wherein the recommendation further presents the recipe to the user.

14. The method of claim 11, wherein the computerized recommendation engine is further configured to generate bypass scores that are utilized to determine whether one or more of the recipes should not be recommended to the user because the user already has knowledge of the one or more of the recipes.

15. The method of claim 11, wherein:
executing the computerized recommendation engine further comprises transmitting the recipe for presenting to the user via the graphic user interface on the electronic device; and
transmitting the recipe occurs before transmitting the data.

16. The method of claim 11, wherein:
the mapping information further correlates certain ones of the grocery products that were previously purchased by the user,
executing the computerized recommendation engine further comprises recommending the recipe selected from the recipes to the user further based in part on the certain ones of the grocery products that were previously purchased by the user; and
the subset of the grocery products included in the recommendation do not include the certain ones of the grocery products that were previously purchased by the user.

17. The method of claim 11, wherein:
each of the recipes are parsed to further identify ingredient amounts for the ingredients included in each of the recipes, and
the subset of the grocery products included in the recommendation are selected based, at least in part, on the ingredient amounts of the ingredients that correspond to the recipe that is selected by the computerized recommendation engine.

18. The method of claim 11, wherein the computerized recommendation engine is configured to analyze feedback associated with prior recommendations of other ones of the recipes that were presented to the user.

19. The method of claim 18, wherein the computerized recommendation engine is configured to analyze the feedback to identify additional recipes included in the recipes that are not of interest to the user in response to determining that the user previously ignored the prior recommendations.

20. The method of claim 1, wherein:
the subset of the grocery products comprise certain ones of the grocery products that correspond to the ingredients for the recipe and that are not included in the online shopping cart before executing the computerized recommendation engine to recommend the recipe;
transmitting the data further comprises transmitting the data for presenting to the user, via the graphic user interface on the electronic device, an indication of other grocery products that (a) correspond to other ones of the ingredients for the recipe and (b) are included in the online shopping cart before executing the computerized recommendation engine to recommend the recipe; and
the subset of the grocery products do not comprise the other grocery products.
